(19) United States
(12) Patent Application Publication
(10) Pub. No.: US 2010/0174863 A1
(43) Pub. Date: Jul. 8, 2010

(54) SYSTEM FOR PROVIDING SCALABLE IN-MEMORY CACHING FOR A DISTRIBUTED DATABASE

(75) Inventors: Brian F. Cooper, San Jose, CA (US); Adam Silberstein, Sunnyvale, CA (US); Utkarsh Srivastava, Emeryville, CA (US); Raghu Ramakrishnan, Saratoga, CA (US); Rodrigo Fonseca, Providence, RI (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/724,260

(22) Filed: Mar. 15, 2010

Related U.S. Application Data
(63) Continuation-in-part of application No. 11/948,221, filed on Nov. 30, 2007.

(51) Int. Cl. G06F 12/08; G06F 17/30

(52) U.S. Cl. 711/113; 707/610; 711/129; 711/216; 707/E17.005; 711/E12.046; 711/E12.018; 711/E12.019

(57) ABSTRACT

A system is described for providing scalable in-memory caching for a distributed database. The system may include a cache, an interface, a non-volatile memory and a processor. The cache may store a cached copy of data items stored in the non-volatile memory. The interface may communicate with devices and a replication server. The non-volatile memory may store the data items. The processor may receive an update to a data item from a device to be applied to the non-volatile memory. The processor may apply the update to the cache. The processor may generate an acknowledgement indicating that the update was applied to the non-volatile memory and may communicate the acknowledgment to the device. The processor may then communicate the update to a replication server. The processor may apply the update to the non-volatile memory upon receiving an indication that the update was stored by the replication server.

### CROSS-REFERENCE TO RELATED APPLICATIONS

This application is a continuation-in-part of U.S. patent application Ser. No. 11/948,221, filed on Nov. 30, 2007, which is incorporated by reference herein.

### TECHNICAL FIELD

The present description relates generally to a system and method, generally referred to as a system, for providing scalable in-memory caching for a distributed database, and more particularly, but not exclusively, to providing scalable in-memory caching for a distributed database utilizing asynchronous replication.

### BACKGROUND

Caches may mask latency and provide higher throughput by avoiding the need to access a database. However, caches are often either an external cache or a per-server cache. External caches may not recognize characteristics of the database's operation, such as native replication, partitioning consistency, or other operation specific characteristics. Thus, external caches may not be reusable across varying database designs and/or implementations. Per server caches may provide caching for local server operations, and not cross-server operations. Thus, per server caches may not operate effectively across a distributed database.

### SUMMARY

A system for providing scalable in-memory caching for a distributed database. The system may include a cache, an interface, a non-volatile memory and a processor. The cache may be operative to store a cached copy of data items stored in the non-volatile memory. The interface may be coupled to the cache and may be operative to communicate with devices and a replication server. The non-volatile memory may be coupled to the cache and may be operative to store the data items. The processor may be coupled to the non-volatile memory, the interface, and the cache, and may be operative to receive, via the interface, an update to one of the data items to be applied to the non-volatile memory. The processor may apply the update to the cache. The processor may generate an acknowledgement which indicates that the update was applied to the data item stored in the non-volatile memory. The processor may provide, via the interface, the acknowledgement to the device. After providing the acknowledgement to the device, the processor may communicate, via the interface, the update to the replication server. The processor may apply the update to the non-volatile memory upon receiving an indication that the data item was stored by the replication server.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a system for providing scalable in-memory caching for a distributed database.

FIG. 2 is a diagram illustrating the process flow for reading data in the system of FIG. 1, or other systems for providing scalable in-memory caching for a distributed database.

FIG. 3 is a diagram illustrating the process flow for writing data in the system of FIG. 1, or other systems for providing scalable in-memory caching for a distributed database.

FIG. 4 is a flowchart illustrating in-memory caching in the system of FIG. 1, or other systems for providing scalable in-memory caching for a distributed database.

FIG. 5 is a flowchart illustrating in-memory caching and replication in the system of FIG. 1, or other systems for providing scalable in-memory caching for a distributed database.

FIG. 6 is a flowchart illustrating partitioned in-memory caching in the system of FIG. 1, or other systems for providing scalable in-memory caching for a distributed database.

FIG. 7 is an illustration of a general computer system that may be used in the systems of FIG. 1, or other systems for providing scalable in-memory caching for a distributed database.

### DETAILED DESCRIPTION

A system and method, generally referred to as a system, may relate to providing scalable in-memory caching for a distributed database, and more particularly, but not exclusively, to providing scalable in-memory caching for a distributed database which utilizes asynchronous replication. The principles described herein may be embodied in many different forms.

The system may increase throughput and decrease the latency of reads and writes in a distributed database system. The throughput may be increased by coalescing successive writes to the same record. The latency may be decreased by accessing data in main memory only and asynchronously committing updates to non-volatile memory, such as a disk. The system may leverage the horizontal partitioning of the underlying database to provide for elastic scalability of the cache. The system may also preserve the underlying consistency model of the database by being tightly integrated with the transaction processing logic of the database server. Thus, each partition of the database maintains an individual cache, and updates to each individual cache are asynchronously committed to disk.

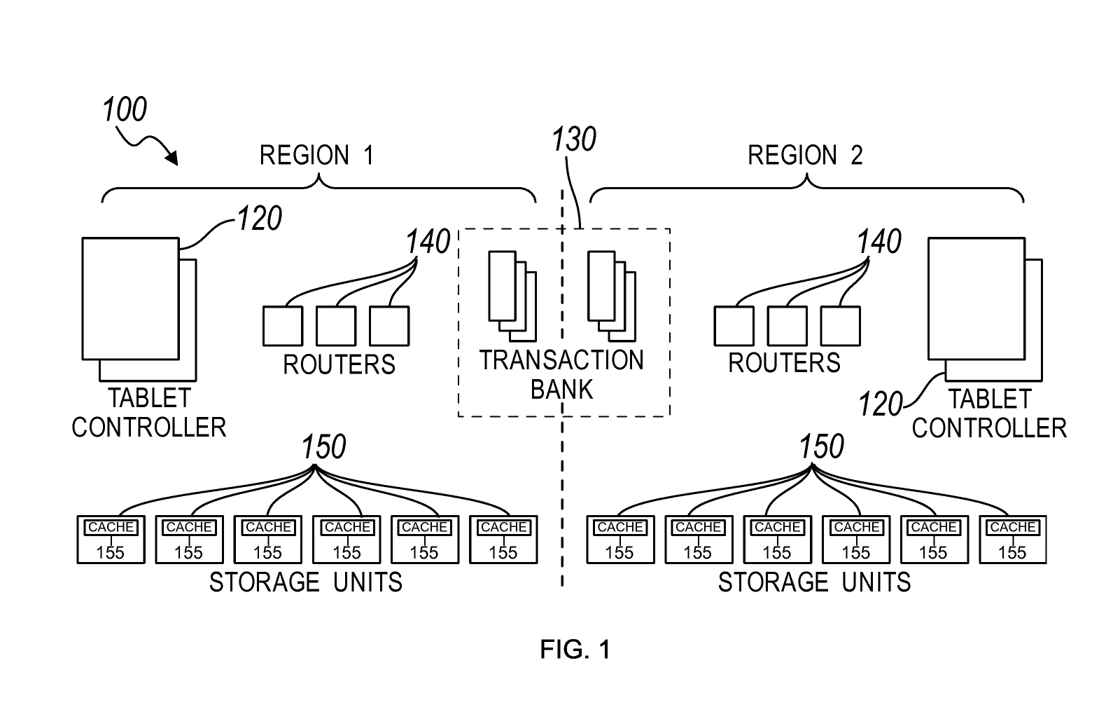

FIG. 1 is a block diagram of an overview a distributed database system 100 which may implement the system for in-memory caching. Not all of the depicted components may be required, however, and some implementations may include additional components. Variations in the arrangement and type of the components may be made without departing from the spirit or scope of the claims as set forth herein. Additional, different or fewer components may be provided.

The system 100 may include multiple data centers that are disbursed geographically across the country or any other geographic region. For illustrative purposes two data centers are provided in FIG. 1, namely Region 1 and Region 2. Each region may be a scalable duplicate of each other, and each region may include a tablet controller 120, routers 140, storage units 150, and a transaction bank 130. Each storage unit 150 may include a cache 155 and a local disk, such as non-volatile memory. A farm of servers may refer to a cluster of servers within one of the regions, such as Region 1 or Region 2, which contains a full replica of the distributed database.

The system 100 may provide a hashtable abstraction, implemented by partitioning data over multiple servers and replicating the data to the multiple geographic regions. The system 100 may partition data into one or more data containers referred to as tablets. A tablet may contain multiple records, such as thousands of records, or millions of records. Each record may be identified by a key. The system 100 may hash the key of a record to determine the tablet associated with the record. The hash table abstraction provides fast lookup and update via the hash function and efficient load-balancing properties across tablets. For explanatory purposes the system 100 is described in the context of hashtable extraction. However, the system 100 may utilize other types of database systems, such as a range-partitioned database, an ordered table database system, or generally any other applicable database system.

The storage units 150 may store and serve data of multiple tablets. Thus the database may be partitioned across the storage units 150. For example, a storage unit 150 may manage any number of tablets, such as hundreds, thousands or millions of tablets. The system 100 may move individual tablets between servers of a farm to achieve fine-grained load balancing. The storage unit 150 may implement the basic application programming interface (API) of the system 100, and each of the storage units 150 may include a cache 155. Each cache 155 may cache the data stored in the associated storage unit 150, such that the caches 155 may be scalable through the horizontal partitioning of the underlying database. For example, the caches 155 may be in-memory shared write-back caches. When each table in the system 100 is created, the table may be identified as cached or non-cached. Alternatively or in addition, each record of each table may be identified as cached or non-cached, each tablet may be identified as cached or non-cached, or generally any data container may be identified as cached or non-cached. The caches 155 may be implemented using a database system which includes write-back cache extensions. The caches 155 may be managed using an internal replacement algorithm, such as least recently used (LRU), greedy dual sized frequency (GDSF) caching, or least frequency used (LFU) caching, or generally any replacement algorithm.

The assignment of the tablets to the storage units 150 is managed by the tablet controller 120. The tablet controller 120 can assign any tablet to any storage unit 150, and may reassign the tablets as necessary for load balancing. To prevent the tablet controller 120 from being a single point of failure, the tablet controller 120 may be implemented using paired active servers. Since the caches 155 reflect the data stored on the associated storage unit 150, the caches may reflect the partitioning of the tablets to the underlying storage units 150.

In order for a client to read or write a record, the client must locate the storage unit 150 holding the appropriate tablet. The tablet controller 120 stores information describing which storage unit 150 stores which tablet. The system API used by clients to access records generally hides the details associated with the tablets. Thus, the clients do not need to maintain information about tablets or tablet locations. The tablet to storage unit mapping is cached in the routers 140, which serve as a layer of indirection between clients and storage units 150. By caching the tablet to storage unit mapping in the routers 140, the system 100 prevents the tablet controller 120 from being a bottleneck during data access. The routers 140 may be application-level components or may be IP-level routers.

In operation, a client may contact any of the routers 140 to initiate a database read or write. When a client requests a record from a router 140, the router may apply the hash function to the key of the record to determine the appropriate tablet identifier (“id”). The router 140 may look up the tablet id in its cached mapping to determine the storage unit 150 currently holding the tablet. The router 140 then forwards the request to the storage unit 150. The storage unit 150 may receive the request and execute the request. In the case of a read operation, a requested data item may be read from the cache 155, if available, and returned to the router 140. If the data item is not stored in the cache 155, the cache 155 may retrieve the requested data item from the local disk of the storage unit 150, and return the data item to the router 140. The router 140 may then forward the data to the requesting client.

If the tablet-to-storage unit mapping of a router 140 is determined to be incorrect, e.g. because a tablet is moved to a different storage unit 150, the storage unit 150 may return an error to the router 140. The router 140 may then refresh the cached copy of the tablet-to-storage unit mapping from the tablet controller 120. Alternatively, to avoid a flood of requests when a tablet is moved, the system 100 may fail requests if the mapping of a router 140 is incorrect, or may forward the request to a remote region. The routers 140 may also periodically poll the tablet controller 120 to retrieve new mappings.

The transaction bank 130 may be responsible for propagating updates made to one record to all of the other replicas of that record, both within a farm and across farms. Thus, the transaction bank 130 may be an active part of the consistency protocol. Clients who use the system 100 to store data may expect updates to individual records to be applied in a consistent order at all replicas. Since the system 100 uses asynchronous replication, updates will not be seen immediately everywhere, but each record retrieved will reflect a consistent version of the record. As such, the system 100 achieves per-record, eventual consistency without sacrificing fast writes in the common case. The system 100 may not require a separate record locking mechanism to maintain data consistency, such as a lock server, lease server or master directory. Instead, the system 100 may serialize all updates to a record, by assigning each update a sequence number. The sequence number may be used to identify updates that have already been applied to avoid applying the updates twice. Data updates may be committed by publishing the update to the transaction bank 130. For example, the storage units 150 may communicate with a local transaction bank broker. Each broker may consist of multiple machines for failover and scalability. Thus, committing an update requires only a fast, local network communication from a storage unit 150 to a transaction bank broker machine.

An update, once accepted as published by the transaction bank 130, may be guaranteed to be delivered to all servers subscribed to the transaction bank 130. The update may be available for re-delivery to any server until the server confirms the update has been applied to its local disk. Updates published in one region may be delivered to the servers in the order they were published. Thus, there may be a per-region partial ordering of messages, but not necessarily a global ordering. These update properties allow the system 100 to treat the transaction bank 130 as a fault tolerant redo log. Thus, once a storage unit 150 receives confirmation that the transaction bank 130 has stored an update, the storage unit 150 may consider the update as committed.

By pushing the complexity of a fault tolerant redo log into the transaction bank 130 the system 100 can easily recover from failures of individual storage units 150. For example, the system 100 does not need to locally preserve any logs on the storage unit 150. Thus, if a storage unit 150 permanently and unrecoverably fails, the system 100 may recover by bringing up a new storage unit 150, and associated cache 155, and populating the storage unit 150 with tablets copied from other farms. Alternatively, the system 100 may reassign the tablets from the failed storage unit 150 to existing, live storage units 150. However, if the cache 155 of a storage unit 150 fails before the updates in the cache 155 are flushed to the transaction bank 130, the updates may be lost permanently. Thus, the cached data may be data which is expendable, or otherwise not essential in the system 100. For example, the cached data may include user click trails, or other traces of user activity.

The consistency scheme requires the transaction bank 130 to reliably maintain the redo log. For example, the transaction bank brokers may use multi-server replication such that data updates are always stored on at least two different disks. The data updates may be stored on two separate disks both when the updates are being transmitted by the transaction bank 130 and after the updates have been written by the storage units 150 in multiple regions. The system 100 may increase the number of replicas in a broker to achieve higher reliability if necessary.

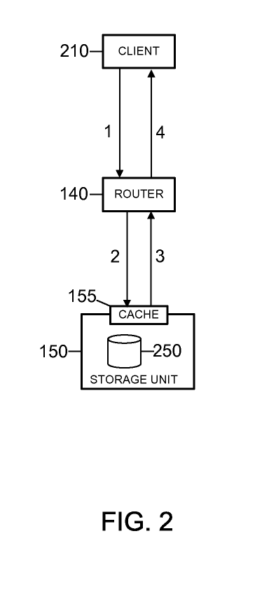

FIG. 2 is a diagram illustrating the process flow for reading data in the system of FIG. 1, or other systems for providing scalable in-memory caching for a distributed database. Not all of the depicted components may be required, however, and some implementations may include additional components. Variations in the arrangement and type of the components may be made without departing from the spirit or scope of the claims as set forth herein. Additional, different or fewer components may be provided.

At step 1, a client 210 may communicate a request for a record to one of the routers 140. For example, the request may include the key of the record. The router 140 may apply a hash function to the key of the record to determine the id of the tablet associated with the record. The router 140 may use the tablet id to identify the storage unit 150, and associated cache 155, where the tablet, and thus the record, is located. At step 2, the router 140 may forward the request to the determined storage unit 150. The storage unit 150 may receive the request and may retrieve the requested record from the cache 155. If the requested data is not stored in the cache 155, the data may be retrieved from the local disk 250. At step 3, the storage unit 150 may return the requested data to the router 140. At step 4, the router 140 may forward the data to the client 210.

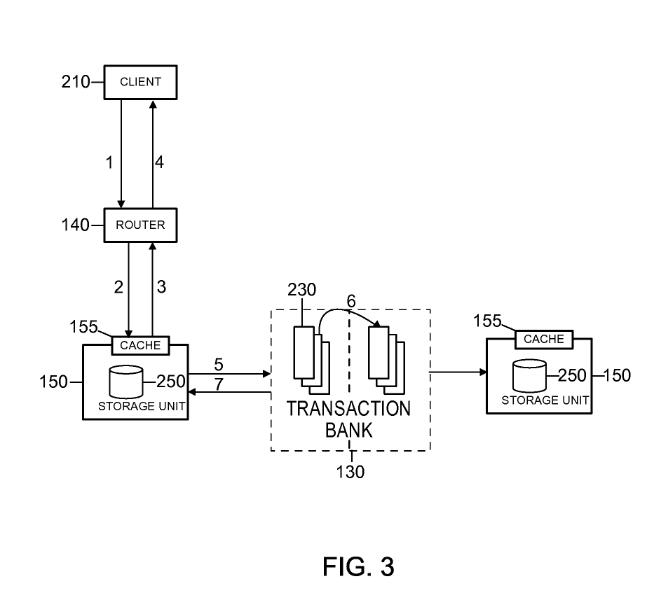

FIG. 3 is a diagram illustrating the process flow of a system 200 for writing data in the system of FIG. 1, or other systems for providing scalable in-memory caching for a distributed database. Not all of the depicted components may be required, however, and some implementations may include additional components. Variations in the arrangement and type of the components may be made without departing from the spirit or scope of the claims as set forth herein. Additional, different or fewer components may be provided.

At step 1, the client 210 may send request to update a record to a router 140. For example, the client 210 may provide a key of a record to be updated and an update to the router 140. The router 140 may apply a hash function to the key of the record to determine the id of the tablet associated with the record. The router 140 may use the tablet id to identify the storage unit 150, and associated cache 155, where the tablet, and record, is located. At step 2, the router 140 may forward the update to the determined storage unit 150. In order to decrease latency, the update may be written to the cache 155 of the storage unit 150, but not the local disk 250 of the storage unit 150. Although the update is only written to the cache 155 of the storage unit 150, the storage unit 150 generates an acknowledgement indicating that the update was committed to the distributed database. For example, the storage unit 150 may increase the current sequence number for the record in the cache, and may generate an acknowledgement containing the increased sequence number. At step 3, the storage unit 150 may communicate the acknowledgement to the router 140. At step 4, the router 140 may forward the acknowledgment to the client 210. The client 210 receives the acknowledgment indicating that the update was committed to the distributed database, even though the update was only written to the cache. Thus, the system 100 is able to provide the caching and replication operations transparent to the client 210.

At step 5, the storage unit 150 flushes the contents of the cache 155 to the local transaction bank broker 230. The storage unit 150 may flush the cache 155 after a period of time elapses, after a number of transactions have been completed in the cache 155, or generally at random intervals. At step 6, the transaction bank 130 may write the data to the redo log, and may otherwise replicate the data. At step 7, the transaction bank broker 230 may communicate a confirmation that the data was written to the log or otherwise stored or replicated. Upon receiving the confirmation, the storage unit 150 may consider the data replicated and may write the data to the local disk 250. The storage unit 150 may also refresh the cache 155 upon writing the data to the local disk 250. Alternatively or in addition, the storage unit 150 may refresh the cache periodically or randomly.

Asynchronously, the transaction bank 130 may propagate the updates to all of the remote storage units 150. The remote storage units 150 may receive the update and may apply the update to their local disks 250. The sequence numbers of each update may allow the storage units 150 to verify that the updates are applied to the records in the proper order, which may ensure that the global ordering of updates to the records is consistent. After applying the updates to the records, the storage unit 150 may signal to the local transaction bank broker that the update may be purged from its log if desired.

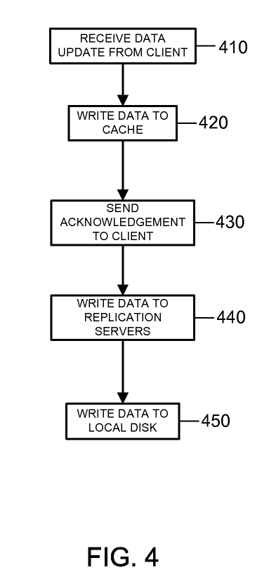

FIG. 4 is a flowchart illustrating in-memory caching in the system of FIG. 1, or other systems for providing scalable in-memory caching for a distributed database. The steps of FIG. 4 are described as being performed by the system 100. However, the steps may be performed by a storage unit 150, a processor in communication with the storage unit 150, or by any other hardware component in communication with the storage unit 150. Alternatively the steps may be performed by another hardware component, such as the devices discussed in FIG. 1 above. The steps of FIG. 4 are described in serial for explanation purposes; however, one or more steps may occur simultaneously, or in parallel.

At step 410, the system 100 may receive a data update from a client 210. At step 420, the system 100 may write the data update to the local cache 155 of the storage unit 150. Although the data update was only written locally to the cache 155, the system 100 may generate an acknowledgment indicating that the data update was committed to the distributed database. For example, the system 100 may increase the sequence number of the updated record and may include the increased sequence number in the acknowledgment. At step 430, the system 100 may communicate the acknowledgement to the client 210, such as through the router 140. Since the acknowledgment indicates that the update was committed to disk, the data caching operations may be transparent to the client 210. At step 440, the system 100 may write the update to one or more replication servers, such as the transaction bank 130. At step 450, the system 100, upon receiving confirmation that the update was successfully stored on the replication servers, writes the update to the local disk 250.

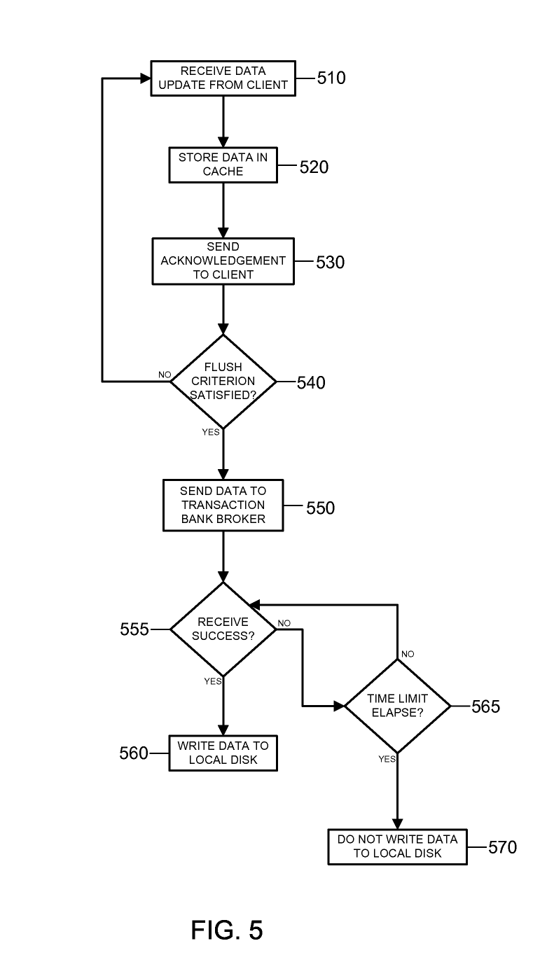

FIG. 5 is a flowchart illustrating an in-memory caching and replication operation in the system of FIG. 1, or other systems for providing scalable in-memory caching for a distributed database. The steps of FIG. 5 are described as being performed by a storage unit 150. However, the steps may be performed by a processor in communication with the storage unit 150, or by any other hardware component in communication with the storage unit 150. Alternatively the steps may be performed by another hardware component, such as the devices discussed in FIG. 1 above. The steps of FIG. 5 are described in serial for explanation purposes; however, one or more steps may occur simultaneously, or in parallel.

At step 510, the storage unit 150 may receive a data update from a client 210. At step 520, the storage unit 150 may store the data update in the local cache 155 of the storage unit 150. The cache 155 may update the sequence number associated with the updated record. At step 530, the storage unit 150 may communicate an acknowledgment to the client 210. Although the data update was only locally written to the cache 155 of the storage unit 150, the acknowledgement may indicate the update was committed to the distributed database in order to keep the caching operations transparent to the client 210. For example, the acknowledgement may include the incremented sequence number associated with the record. At step 540, the storage unit 150 may determine whether the cache flush criterion is satisfied. The cache flush criterion may be any criterion which indicates that the cache 155 should be flushed, such as a period of time, a number of transactions performed in the cache 155, or generally any criteria. Alternatively, or in addition, the cache 155 may be randomly flushed by the storage unit 150. If, at step 540, the storage unit 150 determines the flush criterion is not satisfied, the storage unit 150 returns to step 510 and continues to perform read and write operations on the current cache 155.

If, at step 540, the storage unit 150 determines the flush criterion is satisfied, the storage unit 150 moves to step 550. At step 550, the storage unit 150 communicates the data updates in the cache 155 to the transaction bank 130, such as via a local transaction bank broker 230. The transaction bank 130 may write the updates to the log, or may otherwise replicate the updates. The storage unit 150 may move to step 555 and may determine whether a success acknowledgement was received from the transaction bank 130, indicating that the data update was properly handled by the transaction bank 130. If, at step 555, the storage unit 150 does not receive a success acknowledgement from the transaction bank 130, the storage unit 150 moves to step 565. At step 565, the storage unit 150 determines whether a time limit for receiving a success acknowledgment from the transaction bank 130 has elapsed. For example, the storage unit 150 may have a transaction bank timeout which may indicate a time limit for the transaction bank 130 to communicate the success acknowledgement. If the transaction bank 130 is unable to communicate a success acknowledgment within the time limit, the storage unit 150 may determine the data update was not properly handled by the transaction bank 130.

If at step 565, the storage unit 150 determines the time limit has elapsed, the storage unit 150 moves to step 570. At step 570, the storage unit 150 does not write the data update to the local disk 250. The storage unit 150 may attempt to re-send the data update to the transaction log 130. If, at step 565, the storage unit 150 determines that the time limit has not elapsed, the storage unit 150 may return to step 555 and determine whether the success acknowledgement has been received. If, at step 555, the storage unit 150 determines that the success acknowledgment was received from the transaction bank 130, the storage unit 150 moves to step 560. At step 560, the storage unit 150 writes the data update to the local disk 250.

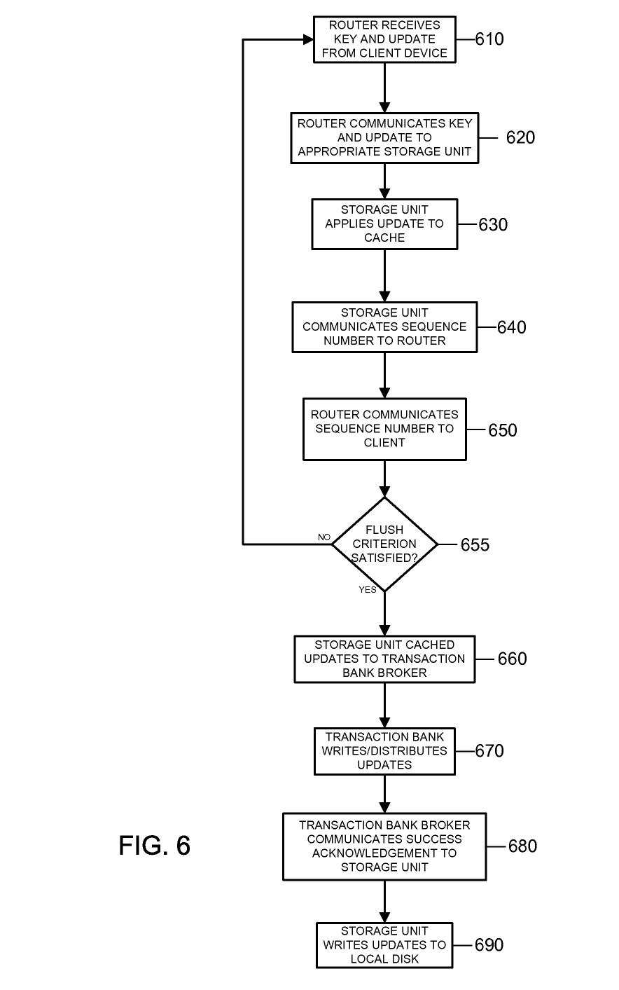

FIG. 6 is a flowchart illustrating a partitioned in-memory caching operation in the system of FIG. 1, or other systems for providing scalable in-memory caching for a distributed database. The steps of FIG. 6 are described as being performed by a storage unit 150. However, the steps may be performed by a processor in communication with the storage unit 150, or by any other hardware component in communication with the storage unit 150. Alternatively the steps may be performed by another hardware component, such as the devices discussed in FIG. 1 above. The steps of FIG. 6 are described in serial for explanation purposes; however, one or more steps may occur simultaneously, or in parallel.

At step 610, a router 140 may receive a key and an update from a client 210. The router 140 may hash the key to determine the storage unit 150 where the record is stored. At step 620, the router 140 may communicate the key and update to the determined storage unit 150. At step 630, the storage unit 150 may write the update to the local cache 155. The sequence number associated with the record may be increased when the record is updated in the local cache 155. At step 640, the storage unit 150 may communicate the increased sequence number to the router 140. At step 650, the router 140 may communicate the updated sequence number to the client 210.

At step 655, the storage unit 150 may determine whether the flush criterion for the local cache 155 is satisfied. The flush criterion may indicate when the data updates in the cache should be sent to the transaction bank 130 or other replication servers. For example the flush criterion may be a period of time, a number of updates stored in the local cache 155, or generally any criteria. If, at step 655, the storage unit 150 determines the flush criterion is not satisfied, the storage unit 150 returns to step 610 and continues to read/write data in the local cache 155. If, at step 655, the storage unit 150 determines the flush criterion is satisfied, the storage unit 150 moves to step 660. At step 660, the storage unit sends the updates in the cache 155 to the transaction bank 130, such as via a transaction bank broker 230. At step 670, the data may be written and/or distributed by the transaction bank 130. Upon successfully writing the updates, such as to a log, the transaction bank 130 may communicate a success acknowledgment to the storage unit 150. At step 150, the storage unit 150 may write the key and updates to the local disk 250, upon receiving the success confirmation from the transaction bank 130.

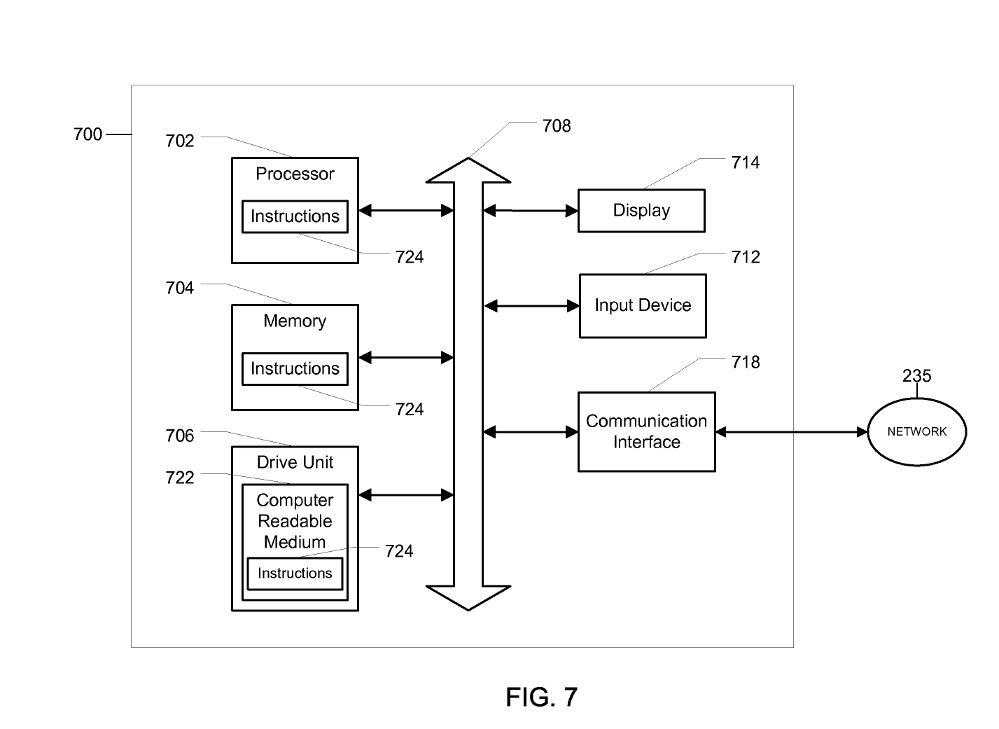

FIG. 7 illustrates a general computer system 700, which may represent a storage unit 150, or any of the other computing devices referenced herein. The computer system 700 may include a set of instructions 724 that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In a particular embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, such as, a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 704 may include a cache or random access memory for the processor 702. Alternatively or in addition, the memory 704 may be separate from the processor 702, such as a cache memory of a processor, the system memory, or other memory. The memory 704 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 may be operable to store instructions 724 executable by the processor 702. The functions, acts or tasks illustrated in the figures or described herein may be performed by the programmed processor 702 executing the instructions 724 stored in the memory 704. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 712 configured to allow a user to interact with any of the components of system 700. The input device 712 may be a number pad, a keyboard, or a cursor control device, such as a mouse, or a joystick, touch screen display, remote control or any other device operative to interact with the system 700.

The computer system 700 may also include a disk or optical drive unit 706. The disk drive unit 706 may include a computer-readable medium 722 in which one or more sets of instructions 724, e.g. software, can be embedded. Further, the instructions 724 may perform one or more of the methods or logic as described herein. The instructions 724 may reside completely, or at least partially, within the memory 704 and/or within the processor 702 during execution by the computer system 700. The memory 704 and the processor 702 also may include computer-readable media as discussed above.

The present disclosure contemplates a computer-readable medium 722 that includes instructions 724 or receives and executes instructions 724 responsive to a propagated signal; so that a device connected to a network 235 may communicate voice, video, audio, images or any other data over the network 235. Further, the instructions 724 may be transmitted or received over the network 235 via a communication interface 718. The communication interface 718 may be a part of the processor 702 or may be a separate component. The communication interface 718 may be created in software or may be a physical connection in hardware. The communication interface 718 may be configured to connect with a network 235, external media, the display 714, or any other components in system 700, or combinations thereof. The connection with the network 235 may be a physical connection, such as a wired Ethernet connection or may be established wirelessly as discussed below. Likewise, the additional connections with other components of the system 700 may be physical connections or may be established wirelessly.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for providing scalable in-memory caching for a distributed database, the method comprising:
receiving a data update from a client, the data update to be applied to a database;
applying the data update to a cache, wherein the cache contains a cached copy of the database;
generating an acknowledgement, wherein the acknowledgment indicates that the data update was applied to the database;
providing the acknowledgement to the client;
communicating, by a processor after providing the acknowledgement, the data update to a replication server; and
applying the data update to the database upon receiving an indication that the data update was stored by the replication server.

2. The method of claim 1 wherein an external process instructs the processor to provide the data update to the replication server.

3. The method of claim 1 wherein communicating, by the processor after providing the acknowledgement, the data update to the replication server further comprises, communicating, by the processor after providing the acknowledgement and after a period of time, the data update to the replication server.

4. The method of claim 1 wherein the database comprises a distributed database.

5. The method of claim 1 further comprising publishing, by the replication server, the data update to a plurality of databases.

6. The method of claim 1 wherein the cache is integrated with the database.

7. The method of claim 1 wherein applying the data update to the cache further comprises:
determining whether the data update comprises an indication that the data update should be applied to the cache; and
applying the data update to the cache if the data update comprises the indication that the data update should be applied to the cache, otherwise not applying the data update to the cache.

8. A method for providing partitioned in-memory caching for a distributed database, the system comprising:
partitioning a database into a plurality of tablets, wherein each of the tablets comprises one or more records of the database;
storing each tablet on one of a plurality of storage units, each of the storage units associated with a local disk and a cache, wherein each cache comprises a cached copy of data stored on the associated storage unit;
receiving an update to a record of the database from a client;
determining the storage unit containing the record;
communicating the update to the determined storage unit;
applying the update to the cache associated with the determined storage unit;
generating an acknowledgement indicating that the update was applied to the record in the database;
providing the acknowledgement to the client;
communicating, after providing the acknowledgement, the update to a replication server; and
writing the update to the local disk of the determined storage unit upon receiving an indication that the update was properly handled by the replication server.

9. The method of claim 8 wherein each record further comprises a sequence number and wherein generating the acknowledgement indicating that the update was applied to the record in the database further comprises:
increasing the sequence number of the record; and
generating an acknowledgment comprising the increased sequence number of the record.

10. The method of claim 8 wherein the replication server comprises a transaction bank.

11. The method of claim 8 wherein writing the update to the local disk of the determined storage unit upon receiving an indication that the update was properly handled by the replication server further comprises:
waiting a period of time for the indication that the update was properly handled by the replication server; and
writing the update to the local disk of the determined storage unit if the indication is received within the period of time, otherwise not writing the update to the local disk of the determined storage unit.

12. The method of claim 8 further comprising publishing, by the replication server, the data item to a plurality of databases.

13. The method of claim 8 wherein the update further comprises a key and wherein determining the storage unit containing the record further comprises hashing the key of the update to determine the storage unit containing the record.

14. The method of claim 8 wherein applying the update to the cache associated with the determined storage unit further comprises:
determining whether the update comprises an indication that the update should be applied to the cache; and
applying the update to the cache if the update comprises the indication that the update should be applied to the cache, otherwise not applying the update to the cache.

15. A system for providing scalable in-memory caching for a distributed database, the system comprising:
a cache operative to store a cached copy of a plurality of data items;
an interface, the interface coupled to the cache, and the interface operative to communicate with a plurality of devices and at least one replication server;
a non-volatile memory, the non-volatile memory coupled to the cache, the non-volatile memory operative to store the plurality of data items;
a processor, the processor coupled to the non-volatile memory, the interface and the cache, the processor operative to receive, via the interface from a device of the plurality of devices, an update to one of the plurality of data items stored in the non-volatile memory, apply the update to the cache, generate an acknowledgement indicating that the update was applied to the non-volatile memory, provide, via the interface to the device of the plurality of devices, the acknowledgement, communicate, via the interface after providing the acknowledgement, the update to the replication server, and apply the data update to the non-volatile memory upon receiving an indication that the update was stored by the replication server.

16. The system of claim 15 wherein an external process instructs the processor to communicate, via the interface after providing the acknowledgment, the update to the data item to the replication server.

17. The system of claim 15 wherein the processor is further operative to communicate, after providing the acknowledgement and after a period of time elapses, the update to the data item to the replication server.

18. The system of claim 15 wherein the non-volatile memory stores a portion of a distributed database.

19. The system of claim 15 wherein the replication server is operative to publish the data item to a plurality of databases.

20. The system of claim 15 wherein the replication server comprises a transaction bank.
